(19) United States
(12) Patent Application Publication
(10) Pub. No.: US 2008/0246343 A1
(43) Pub. Date: Oct. 9, 2008

(54) POWER SUPPLY ADAPTER FOR USB DEVICES

(75) Inventor: FENG XU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/930,170

(22) Filed: Oct. 31, 2007

(30) Foreign Application Priority Data
Apr. 6, 2007 (CN) 200710200409.8

(51) Int. Cl. H01H 47/00

(52) U.S. Cl. 307/126

(57) ABSTRACT

A power supply adapter for an electronic device includes a power interface and a switch element. The power interface is used for being connected to a power line of the electronic device, for providing power to the electronic device. The switch element is used for being coupled between a power line of a computer and the power line of the electronic device. The switch element has a controllable terminal coupled to the power interface. The switch element is able to disconnect the power lines of the computer and the electronic device according to the voltage level on the controllable terminal.

### BACKGROUND

1. Field of the Invention

The present invention relates to power supplies. Particularly, the present invention relates to power adapters for universal serial bus devices.

2. Description of Related Art

Electronic devices, such as portable storage devices, portable media players, use universal serial bus (USB) interfaces to communicate with computers. Common USB's have data lines for transmitting data and power lines for providing power to the electronic devices from power modules in the computers.

However, power consumption of computers becomes greater as technology provides more USB dependent devices desired by consumers. Consequently, it has become a problem for the power modules in the computers to provide power for extra devices. Therefore, a need exists in the industry to provide power supply adapters for the electronic devices.

### SUMMARY

In one embodiment, a power supply adapter for an electronic device includes a power interface and a switch element. The power interface is used for being connected to a power line of the electronic device, for providing power to the electronic device. The switch element is used for being coupled between a power line of a computer and the power line of the electronic device. The switch element has a controllable terminal coupled to the power interface. The switch element is able to disconnect the power lines of the computer and the electronic device according to the voltage level on the controllable terminal.

Other advantages and novel features of the present power supply adapter will become more apparent from the following detailed description of preferred embodiments when taken in conjunction with the accompanying drawings, in which:

### BRIEF DESCRIPTION OF THE DRAWINGS

FIG. 1 is a schematic isometric view of a power supply adapter connected to a computer and an electronic device in accordance with an exemplary embodiment of the present invention; and

FIG. 2 is a schematic circuit diagram of the power supply adapter of FIG. 1.

### DETAILED DESCRIPTION

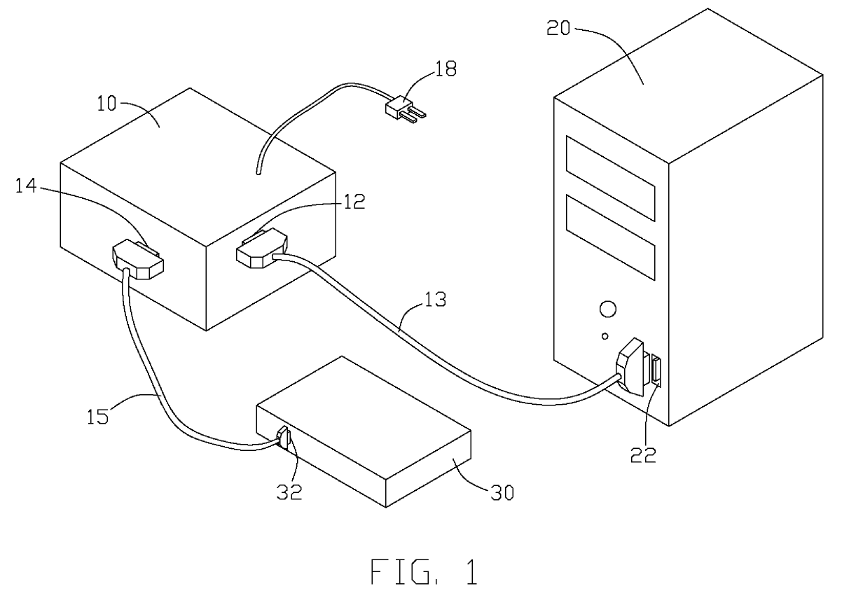

Referring to FIG. 1, a power supply adapter 10 in accordance with an exemplary embodiment is used for providing power to an electronic device 30 with a universal serial bus (USB) interface 32. The power supply adapter 10 has a first interface 12 to communicate with a computer 20 having a USB interface 22 using a first line 13 and a second interface 14 to communicate with the electronic device 30 using a second line 15. The power supply adapter 10 also has a power interface 18 to be connected to an external power supply (not shown). The power supply may be of any kind, including AC and DC. The electronic device 30 may be an external hard disk drive.

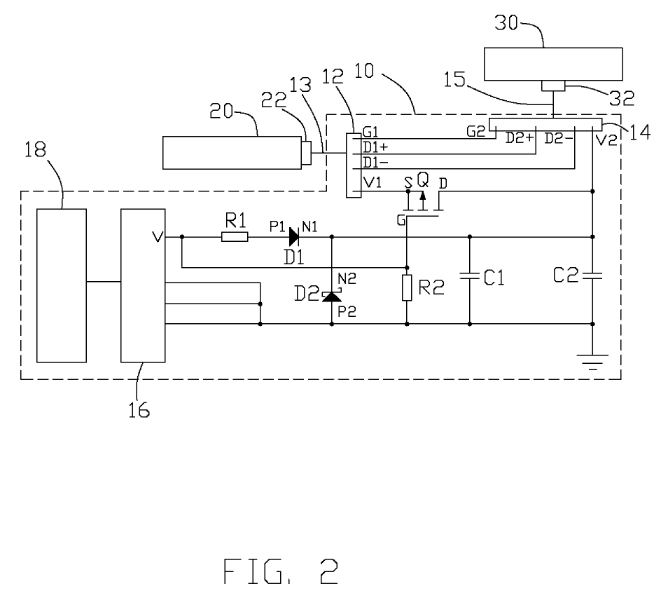

Referring to FIG. 2, the power supply adapter 10 includes a converter circuit 16 coupled to the power interface 18. The converter circuit 16 converts voltage provided by the power interface 18 to desired level. The converter circuit 16 has a voltage output terminal V for providing the converted voltage.

In the embodiment, both of the first and second interfaces 12 and 14 are USB interfaces, respectively having ground lines G1 and G2, data lines D1+ and D2+, data lines D1− and D2−, and power lines V1 and V2. The voltage output end V of the converter circuit 16 is connected to the power line V2 of the second interface 14 through a first resistor R1 and a first diode D1. The anode P1 of the first diode D1 is connected to the first resistor R1, and the cathode N1 of the first diode D1 is connected to the power line V2 of the second interface 14. The first resistor R1 can be a fuse, which is able to cut off the circuit if current applied thereto becomes too great. The voltage output terminal V of the converter circuit 16 is also connected to ground through a second resistor R2. Two capacitors C1 and C2 are coupled between the power line V2 and ground, with the two capacitors connected in parallel. A second diode D2 is also provided between the power line V2 and ground, with the anode P2 connecting to ground and the cathode N2 connecting to the power line V2. In the embodiment, the second diode D2 is a Zener Diode, which is able to provide a stabilized voltage between the anode P2 and the cathode N2 thereof.

The power supply adapter 10 also includes a switch element Q. The switch element Q can be a Bipolar Junction Transistor (BJT), a Field Effect Transistor (FET), or an Insulated Gate Bipolar Transistor (IGBT). The gate G of the switch element Q is connected to the voltage output terminal V of the converter circuit 16; the source S of the switch element Q is connected to the power line V1 of the first interface 12; and the drain D of the switch element Q is connected to the power line V2 of the second interface 14.

During use, the computer 20 provides power to the electronic device 30, the power line V1 of the first interface 12 thus receives a high level voltage. Therefore, the switch element Q is conductive, and the voltage of the power line V2 of the second interface 14 is kept high. The electronic device 30 is powered by the computer 20, accordingly.

If the computer 20 is not able to provide the high level voltage for the electronic device 30, the power interface 18 is coupled to the external power supply. The voltage output terminal V outputs a high level voltage, which makes the voltage level on the gate of the switch element Q high. Therefore, the switch element Q is not conductive, and the voltage provided by the computer 20 cannot be coupled to the electronic device 30. On the other hand, the voltage output terminal V of the converter circuit 16 provides the high level voltage to the power line V2 of the second interface 14 through the first resistor R1 and the first diode D1. The electronic device 30 is powered by the external power supply, accordingly. The voltage level on the power line V2 of the second interface 14 is stabile due to the second diode D2 having voltage-stabilization function and the capacitors C1 and C2 with noise-filter functions coupled thereto and ground.

Obviously, in view of integration and simplicity, the power supply adapter 10 can be integrated into the electronic device 30 or the computer 20.

The power supply adapter as described above can be switched to provide power for the electronic device using the power provided by the computer or the external power supply, which ensures stability of the electronic device, and avoids data error, and physical error that may occur to the electronic device and the computer due to insufficient power being supplied.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A power supply adapter for an electronic device comprising:
a power interface for being connected to a power line of a universal serial bus (USB) interface of the electronic device, for providing power to the electronic device;
a switch element coupled between a power line of a USB interface of a computer and the power line of the USB interface of the electronic device, the switch element having a controllable terminal coupled to the power interface; wherein
the switch element is able to disconnect the power lines of the USB interfaces of the computer and the electronic device according to the voltage level on the controllable terminal.

2. The power supply adapter as described in claim 1, wherein the switch element connects the power lines if the voltage level on the controllable terminal is low, and disconnects the power lines if the voltage level on the controllable terminal is high.

3. The power supply adapter as described in claim 2, wherein the switch element is one of a bipolar junction transistor, a field effect transistor, and an insulated gate bipolar transistor.

4. The power supply adapter as described in claim 3, wherein the gate of the switch element is connected to the power interface; the source of the switch element is connected to the power line of the computer; and the drain of the switch element is connected to the power line of the electronic device.

5. The power supply adapter as described in claim 1, further comprising a first resistor and a first diode, the power interface being connected to the power line of the electronic device through the first resistor and the first diode, with the anode of the first diode connecting to the first resistor and the cathode of the diode connecting to the power line of the electronic device.

6. The power supply adapter as described in claim 5, further comprising a converting circuit coupled to the power interface for converting voltages provided by the power interface to be of predetermined values.

7. The power supply adapter as described in claim 5, wherein the first resistor is a fuse.

8. The power supply adapter as described in claim 1, wherein the power interface is connected to an external power supply, for providing power for the electronic device.

9. The power supply adapter as described in claim 1, wherein the power interface is connected to ground through a second resistor.

10. The power supply adapter as described in claim 1, further comprising at least one capacitor for being coupled between the power line of the electronic device and ground.

11. The power supply adapter as described in claim 1, further comprising a second diode for being coupled between the power line of the electronic device with the cathode thereof and ground with the anode thereof.

12. The power supply adapter as described in claim 11, wherein the second diode is a Zener diode.

13. The power supply adapter as described in claim 1, further comprising a first interface for being connected to the computer and a second interface for being connected to the electronic device, the first and second interfaces connected for communications between the computer and the electronic device.

14. The power supply adapters as described in claim 13, wherein the first and second interfaces are universal serial bus interfaces.

15. A power supply circuit for an electronic device comprising:
a computer;
an external electronic device with a universal serial bus (USB) interface;
a power supply adaptor comprising a first USB interface coupled to the computer, a second USB interface coupled to the USB interface of the external electronic device, and a power interface coupling an external power supply to the second USB interface, a switch element having a power terminal connected to the first USB interface, a receiving terminal connected to the second USB interface, and a controllable terminal coupled to the power interface, wherein
according to a comparison result between voltage levels of the power terminal and the controllable terminal, the switch element controls the second USB interface connecting to one of the first USB interface to receive power from the computer, and the power interface to receive power from the external power supply.

16. The power supply circuit as claimed in claim 15, wherein the power interface is coupled to the second interface via a resistor and a diode connected in series, the anode of the diode is connected to the resistor, and the cathode of the diode is connected to the second interface.

17. The power supply circuit as claimed in claim 15, wherein the controllable terminal of the switch element is grounded via a resistor.
